(19) United States
(12) Patent Application Publication
(10) Pub. No.: US 2015/0281768 A1
(43) Pub. Date: Oct. 1, 2015

(54) WIRELESS COMMUNICATION CONNECTORS

(71) Applicant: Mildred Lyles, Sandy Springs, GA (US)

(72) Inventor: Mildred Lyles, Sandy Springs, GA (US)

(21) Appl. No.: 14/225,082

(22) Filed: Mar. 25, 2014

(51) Int. Cl. H04N 21/4363; H04N 5/44; H04N 5/38

(52) U.S. Cl. CPC H04N 21/43635; H04N 5/38; H04N 5/44

(57) ABSTRACT

Implementations of a wireless communication connector are provided. In some implementations, the wireless communication connector comprises a housing, a end terminal, and a transmitter and/or receiver. Implementations of a wireless communication connector according to the present disclosure is configured to physically connect to an input and/or output port of a device (e.g., a content display device or content source) to receive or send data wirelessly from or to another wireless communication connector. The end terminal of a wireless communication connector according to the present disclosure can be a coaxial interface; a high-definition multimedia interface (HDMI) terminal; an Ethernet terminal, or any terminal suitable for use with audio, visual or data communication equipment. Implementations of a wireless communication connector according to the present disclosure are configured to process a wireless signal received from another wireless communication connector for use by the attached device. Still further, implementations of a wireless communication connector according to the present disclosure are configured to process a signal from an attached device for wireless transmission to another wireless communication connector attached to another device.

### TECHNICAL FIELD

This disclosure relates to implementations of a wireless communication connectors.

### BACKGROUND

There are a variety of content sources for TVs, computers, personal electronic devices, and other content display devices. Content sources may include, e.g., a DVD player, a Blu-Ray player, a cable box, cable outlet, a router, a modem, and/or a cable modem. These content sources require a variety of connecters, e.g., high-definition multimedia interface (HDMI), 8 position 8 contact (Ethernet), coaxial, and RCA connectors. These connectors are typically associated with wires. These wires can become unmanageable and/or unsightly when multiple content sources are used for one or more content display devices in one or more locations, for example, in a home.

U.S. Pat. No. 8,063,996 (“'996 patent”) discloses a local content converter, connected to a content source, that is capable of wirelessly transmitting a signal to a TV. The '996 patent disclosures that an antenna connected to an RF input port on the TV is used to wirelessly receive video content from the local content converter. The '996 patent also discloses that video content sources such as a conventional DVD player, set top box, or any other device that produces image data is connected to the local content controller via a physical connection.

However, the system disclosed in the '996 patent has several disadvantages. First, the local content converter can wirelessly transmit a signal only to a TV. Second, the '996 patent does not disclose that a conventional DVD player, set top box, or any other device that produces image data (except for a PC) can wirelessly transmit to the local content converter. Third, the '996 patent does not disclose that a content source such as a set top box can receive or transmit content wirelessly. Fourth, the '996 patent does not disclose that two content sources can communicate wirelessly.

For example, the '996 patent does not disclose that a cable box and a cable wall outlet can communicate wirelessly. As another example, the '996 patent does not disclose that a router and cable modem can communicate wirelessly. Fifth, the '996 patent does not disclose wireless two-way communication. The '996 patent only discloses one way communication to a TV. Sixth, the system disclosed in the '996 patent does not disclose an all wireless system.

### BRIEF DESCRIPTION OF THE DRAWINGS

FIG. 1A illustrates an example wireless communication connector 100 according to the present disclosure.

FIG. 1B illustrates another example wireless communication connector 101 according to the present disclosure.

FIG. 1C illustrates yet another example wireless communication connector 102 according to the present disclosure.

FIG. 2 illustrates a three piece wireless communication connector 200 according to the present disclosure.

FIG. 3 illustrates an example environment of the present disclosure for using wireless communication connectors.

### DETAILED DESCRIPTION

Implementations of a wireless communication connector are provided. In some implementations, the wireless communication connector comprises a housing, a end terminal, and a transmitter and/or receiver.

Implementations of a wireless communication connector according to the present disclosure is configured to physically connect to an input and/or output port of a device (e.g., a content display device or content source) to receive or send data wirelessly from or to another wireless communication connector.

The end terminal of a wireless communication connector according to the present disclosure can be a coaxial interface; a high-definition multimedia interface (HDMI) terminal; an Ethernet terminal, or any terminal suitable for use with audio, visual or data communication equipment.

Implementations of a wireless communication connector according to the present disclosure are further configured to process a wireless signal received from another wireless communication connector for use by the attached device.

Still further, implementations of a wireless communication connector according to the present disclosure are further configured to process a signal from an attached device for wireless transmission to another wireless communication connector attached to another device.

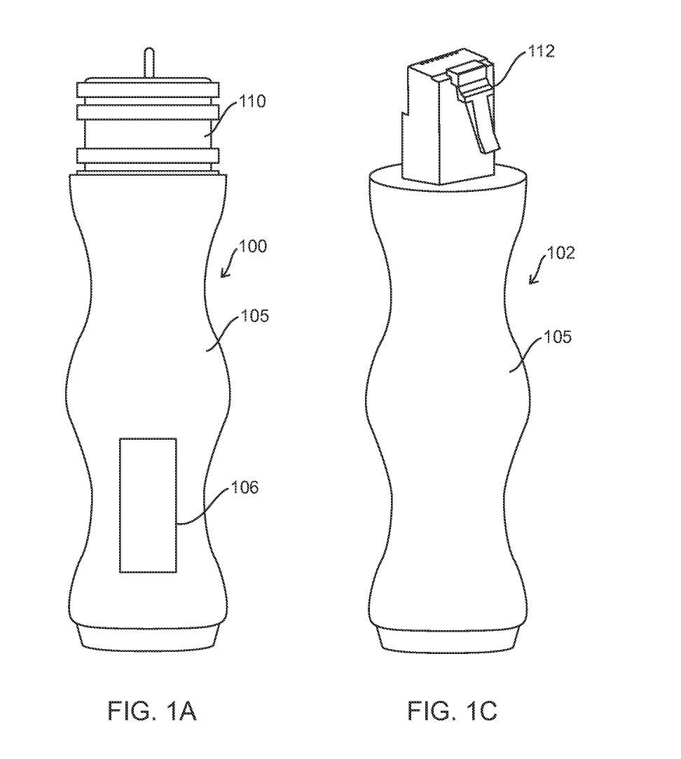

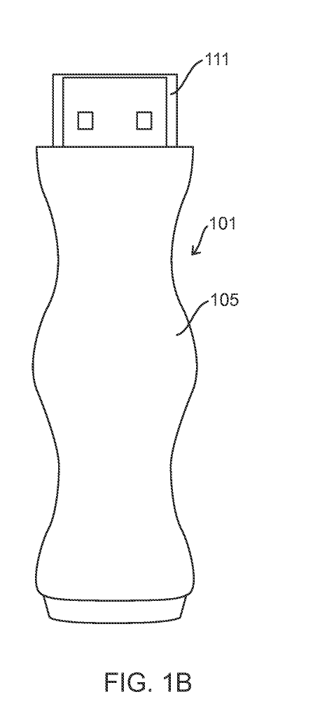

FIG. 1A-1C illustrate example wireless communication connectors 100, 101, 102 according to the present disclosure. A wireless communication connector (e.g., connector 100, 101, 102) comprises a housing 105, an end terminal (e.g., 110, 111, 112, respectively), a transmitter and/or receiver 106. In some implementations the transmitter can include an encoder, a modulator, and an antenna, among other components. In some implementations, the receiver can include an antenna, a decoder, and a demodulator, among other components. One of ordinary skill in the art would know how to make a transmitter and/or receiver 106 to achieve the functions of the present disclosure.

Implementations of a wireless communication connector (e.g. 100, 101, 102) according to the present disclosure is configured to physically connect to an input and/or output port of a device (e.g., a content display device or content source) to receive or send data wirelessly from or to another wireless communication connector (e.g. 100, 101, 102). The end terminal of a wireless communication connector can be a coaxial interface (see, e.g. FIG. 1A) for connecting to, for example, a cable outlet, a cable modem, a television, or a cable box; a high-definition multimedia interface (HDMI) terminal (see, e.g. FIG. 1B) for connecting to, for example, a blue ray player, a cable box, a television, or a DVD player; an Ethernet terminal (see, e.g. FIG. 1C) for connecting to, for example a cable modem, a router, or a personal computer, or any terminal suitable for use with audio, visual or data communication equipment.

Implementations of a wireless communication connector according to the present disclosure may be further configured to process a wireless signal received from another wireless communication connector for use by the attached device. For example, a wireless communication connector attached to a personal computer can be configured to process a wireless signal received from a cable modem. One of ordinary skill in the art would know how to process a wireless signal received from one device for use by another device.

Still further, implementations of a wireless communication connector according to the present disclosure may be further configured to process a signal from an attached device for wireless transmission to another wireless communication connector attached to another device. One of ordinary skill in the art would know how to process a signal or data for wireless transmission.

Using implementations of a wireless communication connector according to the present disclosure, a content source and receiving device (e.g., another content source or content display device) can wirelessly communicate with each other by physically connecting a corresponding wireless communication connector to the input and/or output port of the content source and physically connecting a corresponding wireless communication connector to the input and/or output port of the receiving device. Because each wireless communication connector has an end terminal suitable for use with the input and/or output port of the existing content source or receiving device, the content source and receiving device can be adapted for wireless transmission by physically connecting the wireless communication connectors to the input and/or output port of the content source and receiving device. Thus, by physically connecting a corresponding wireless communication connector to the input and/or output port of an existing device (e.g., content source or content display device) for wireless communications, the use of wires for content sources and receiving devices can be reduced or eliminated.

In some implementations, the housing 105 of the wireless communication device 100,101,102 may be rigid. In some implementations, the housing 105 of the wireless communication device 100,101,102 may be flexible. In some implementations, the housing 105 may be manufactured from a polymer. In some implementations, the housing 105 may be manufactured from a metal. In some implementations, the housing 105 is manufactured from any suitable material. In some implementations, the housing 105 may be constructed to contain therein a transmitter and/or receiver 106 (see, e.g., FIG. 1A).

FIG. 4 illustrates an example environment 400 of the present disclosure for using the wireless communication connectors (e.g., connectors 100, 101, 102) according to the present disclosure. As shown, a plurality of wireless communication connectors (e.g., 100, 101, 102) may be used for wireless transmission between devices (e.g., content sources 405 and/or content display devices 410) to wirelessly place content sources 405, content display devices 410, or a combination thereof into communication with each other. In some implementations, a content source may be a. DVD player, a Blu-Ray player, a cable box, cable outlet, a router, a modem, and/or a cable modem, or any other device that provides an audio, video, or data output, for example. In some implementations, a content display device may be a TV, personal computer, lap top, tablet, or other personal electronic device.

In some implementations, a content source may be able to transmit a signal, receive a signal, or both using wireless communication connector(s) (e.g., connectors 100, 101, 102) according to the present disclosure. In some implementations, a content display device may be able to transmit a signal, receive a signal, or both using wireless communication connector(s) (e.g., connectors 100, 101, 102) according to the present disclosure. In some implementations, the signal received by a content display device or a content source may be an audio signal, a visual signal, a data signal, or combination thereof. In some implementations, the signal transmitted by a content display device 410 or a content source 405 may be an audio signal, a visual signal, a data signal, or combination thereof.

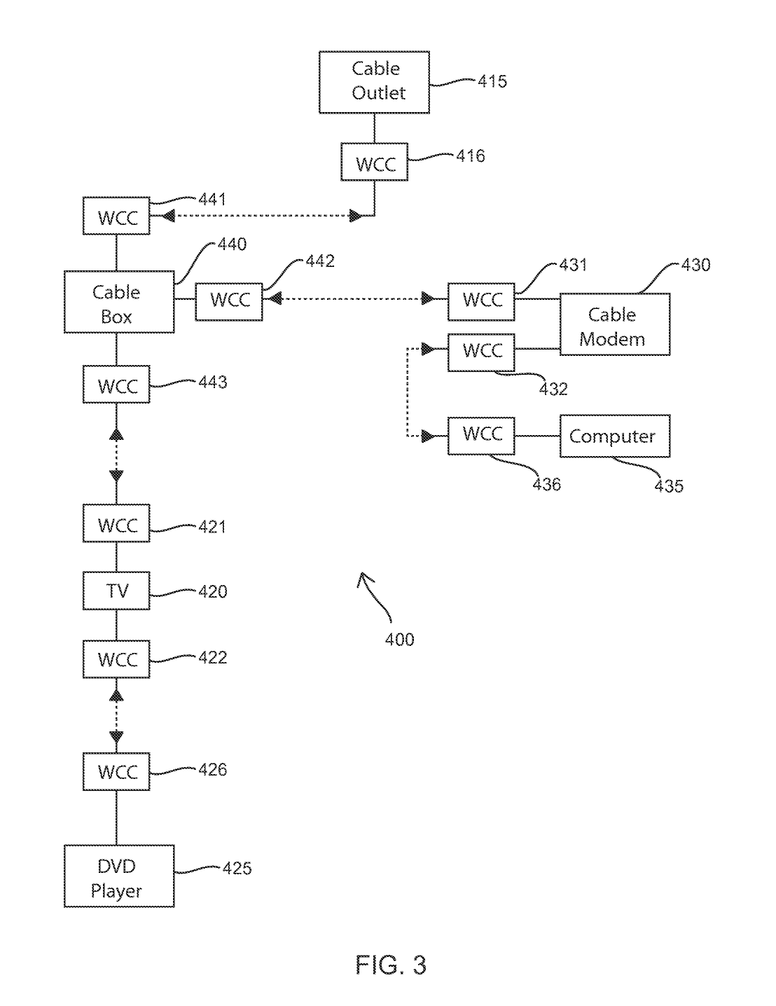

In some implementations, as shown in FIG. 3, the example environment 400 comprises a DVD player 425, a cable box 440, cable outlet 415, cable modem 430, TV 420, and computer 435 each equipped with one or more wireless communication connectors (e.g., connectors 100, 101, 102) according to the present disclosure.

The cable outlet 415 is equipped with a wireless communication connector 416 to wirelessly communicate with a cable box 440 equipped. with a first wireless communication connector 441. In some implementations, the end terminal of the wireless communication connector 416 can be a coaxial interface (see, e.g. FIG. 1A). In some implementations, the end terminal of the wireless communication connector 441 can be a coaxial interface (see, e.g. FIG. 1A).

Wireless communication connector 416 is configured to process a signal from the cable outlet 415 for wireless transmission to the wireless communication connector 441 attached to the cable box 440. One of ordinary skill in the art would know how to process a signal or data from the cable outlet 415 for wireless transmission to the wireless communication connector 441 attached to the cable box 440. The wireless communication connector 441 is configured to process the wireless signal received from the wireless communication connector 416 for use by the cable box 440. One of ordinary skill in the art would know how to process a wireless signal received from the cable outlet 415 for use by the cable box 440.

The cable box 440 is further equipped with a second and a third wireless communication connector 442, 443, respectively. In some implementations, the end terminal of the wireless communication connectors 442, 443 can be an Ethernet terminal (see, e.g. FIG. 1C).

The second wireless communication connector 442 of the cable box 440 wirelessly communicates with a cable modern 430 through an attached first wireless communication connector 431. Wireless communication connector 442 is configured to process a signal from the cable box 440 for wireless transmission to the wireless communication connector 431 attached to the cable modem 432. One of ordinary skill in the art would know how to process a signal or data from the cable box 440 for wireless transmission to the wireless communication connector 431 attached to the cable modem 430. The wireless communication connector 431 is configured to process the wireless signal received from the wireless communication connector 442 for use by the cable modem 430. One of ordinary skill in the art would know how to process a wireless signal received from the cable box 440 for use by the cable modem 430.

The third wireless communication connector 443 of the cable box 440 wirelessly communicates with a digital TV 420 through an attached first wireless communication connector 421. Wireless communication connector 443 is configured to process a signal from the cable box 440 for wireless transmission to the wireless communication connector 421 attached to the TV 420. One of ordinary skill in the art would know how to process a signal or data from the cable box 440 for wireless transmission to the wireless communication connector 421 attached to the TV 420. The wireless communication connector 421 is configured to process the wireless signal received from the wireless communication connector 443 for use by the TV 420. One of ordinary skill in the art would know how to process a wireless signal received from the cable box 440 for use by the TV 420.

The cable modem 430 is further equipped with a second wireless communication connector 432 to wirelessly communicate with a computer 435 equipped with a first wireless communication connector 436. In some implementations, the end terminal of the wireless communication connectors 432, 436 can be an Ethernet terminal (see, e.g. FIG. 1C). Wireless communication connector 432 is configured to process a signal from the cable modem 430 for wireless transmission to the wireless communication connector 436 attached to the computer 435. One of ordinary skill in the art would know how to process a signal or data from the cable modem 430 for wireless transmission to the wireless communication connector 436 attached to the computer 435. The wireless communication connector 436 is configured to process the wireless signal received from the wireless communication connector 432 for use by the computer 435. One of ordinary skill in the art would know how to process a wireless signal received from the cable modem 430 for use by the computer 435.

The TV 420 is further equipped with a second wireless communication connector 422 to wirelessly communicate with a DVD player 425 equipped with a wireless communication connector 426. In some implementations, the end terminal of the wireless communication connectors 422, 426 can be a HDMI terminal (see, e.g. FIG. 1B).

Wireless communication connector 422 is configured to process a signal from the TV 420 for wireless transmission to the wireless communication connector 426 attached to the DVD player 425. One of ordinary skill in the art would know how to process a signal or data from the TV 420 for wireless transmission to the wireless communication connector 426 attached to the DVD player 425. The wireless communication connector 426 is configured to process the wireless signal received from the wireless communication connector 422 for use by the DVD player 425. One of ordinary skill in the art would know how to process a wireless signal received from the TV 420 for use by the DVD player 425.

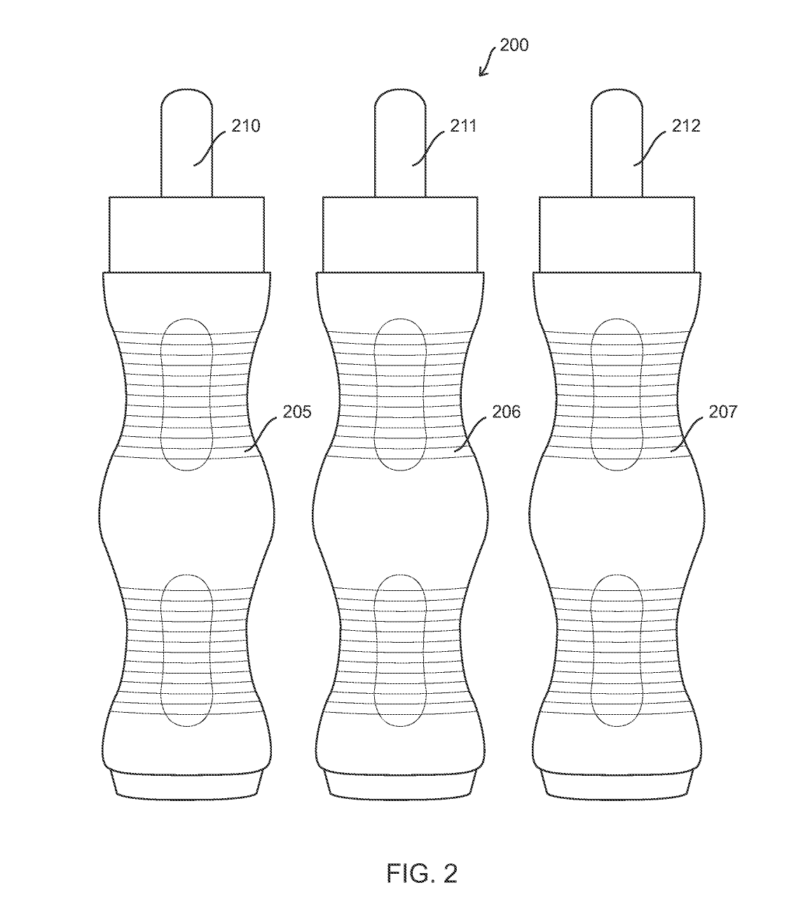

FIG. 2 illustrates a three piece wireless communication connector 200 according to the present disclosure. In some implementations, implementations of the three piece wireless communication connector 200 can be used with devices that use RCA connectors. The wireless communication connector 200 comprises three separate housings 205,206,207, each having an end terminal 210, 211, 212. In some implementations, the end terminals of the wireless communication device 200 are identical. In some implementations, the end terminals 210,211,212 are RCA interfaces. Accordingly, one connector of the three piece wireless communication connector 200 can be used for the video terminal of a device and the other two connectors of the three piece wireless communication connector 200 can be used for the audio terminals of a device.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A wireless communication connector for transmitting and receiving audio, video and other data signals, comprising:
a housing containing a transmitter and a receiver;
an end terminal extending from the housing, the end terminal configured to connect with a port of a device; wherein
the transmitter is configured to receive an input signal from the device and process the input signal for wireless transmission; and
the receiver is configured to receive a wireless signal and process the wireless signal into an output signal usable by the device.

2. The wireless communication connector of claim 1 wherein the housing is constructed from a rigid material.

3. The wireless communication connector of claim 1 wherein the end terminal is a coaxial interface.

4. The wireless communication connector of claim 1 wherein the end terminal is a high-definition multimedia interface.

5. The wireless communication connector of claim 1 wherein the end terminal is an Ethernet interface.

6. A wireless communication system for transmitting and receiving audio, video and other data signals using the wireless connector of claim 1, the system comprising:
a first device having a first wireless connector attached thereto; and
a second device having a second wireless connector attached thereto;
wherein the first wireless connector is configured to receive and process a signal from the second wireless connector and the second wireless connector is configured to receive and process a signal from the first wireless connector.

7. The system of claim 6 wherein the first device is a content source and the second device is a content display device.

8. The system of claim 6 wherein the first device is a content source and the second device is a content source.

9. The system of claim 6 wherein the first device is a content display device and the second device is a content display device.

10. The system of claim 6 wherein the first device is a cable outlet and the second device is a cable box.

11. The system of claim 6 wherein the first device is a cable outlet and the second device is a modem.

12. The system of claim 6 wherein the first device is a modem and the second device is a personal electronic device.

13. The system of claim 6 wherein the first device is a TV and the second device is a cable box.

14. The system of claim 6 wherein the first device is a TV and the second device is a DVD player.

15. The system of claim 6 wherein the first device is a TV and the second device is a Blu-Ray player.

16. The system of claim 6 wherein the first device is a TV and the second device is a personal electronic device.

17. A method of converting a device into a wireless device for transmitting and receiving audio, video and other data signals using the wireless connector of claim 1, the method comprising:
attaching a first wireless connector to a first device; and
attaching a second wireless connector to a second device,
wherein the first wireless connector is configured to receive and process a signal from the second wireless connector and the second wireless connector is configured to receive and process a signal from the first wireless connector.

18. The method of claim 17 wherein the first device is a content source and the second device is a content display device.

19. The method of claim 17 wherein the first device is a content source and the second device is a content source.

20. The method of claim 17 wherein the first device is a content display device and the second device is a content display device.
